(19) United States
(12) Patent Application Publication
(10) Pub. No.: US 2014/0102625 A1
(43) Pub. Date: Apr. 17, 2014

(54) METHOD FOR FIBRE PLACEMENT WITH THE AID OF A TEMPERATURE-REGULATED ROLLER

(71) Applicant: AIRBUS OPERATIONS S.A.S., Toulouse (FR)

(72) Inventor: Denis De Mattia, Basse Goulaine (FR)

(73) Assignee: AIRBUS OPERATIONS S.A.S., Toulouse (FR)

(21) Appl. No.: 14/048,162

(22) Filed: Oct. 8, 2013

(30) Foreign Application Priority Data
Oct. 12, 2012 (FR) 1259739

(51) Int. Cl. B32B 5/26

(52) U.S. Cl. CPC B32B 5/26
USPC 156/166; 156/437

(57) ABSTRACT

A method for fibre placement with the aid of a roller is provided. The roller is able to pivot about a rotation axis and to lay a plurality of first pre-impregnated fibres on second pre-impregnated fibres of a laying surface by rolling over said laying surface. The first fibres being distributed along a lower generatrix of the roller and being in contact with an outer surface of said roller over a contact arc. The method includes cooling the first pre-impregnated fibres in contact with the roller so as to enable them to slide on the outer surface of the roller and heating the second pre-impregnated fibres of the laying surface that are located at the front of the roller so as to promote the adhesion of the first fibres to the second fibres of the laying surface.

### CROSS-REFERENCE TO RELATED APPLICATION

This application claims priority to French Patent Application No. 12 59739, filed Oct. 12, 2012, which is incorporated herein by reference in its entirety.

### TECHNICAL FIELD

This application pertains to a method for fibre placement with the aid of a temperature-regulated roller. According to one embodiment, a piece made of composite material is produced from a preform of fibres subjected to a polymerization cycle. The technical field relates more specifically to preforms produced from fibres pre-impregnated with resin which are subsequently polymerized during a step of consolidation without addition of resin.

### BACKGROUND

When the surface of the mould is developable, it is possible to use draping machines which are intended to lay sheets of fibres on the mould, it being possible for the dimensions of said sheets of fibres to meet those of the piece. In this case, each layer may consist of a single sheet.

When the surface of the mould is not developable, it is possible to use a fibre placement machine for simultaneously laying a plurality of fibres positioned side-by-side. Thus, a fibre placement machine makes it possible to lay a strip of fibres upon each pass.

As a variant, a placement machine may make it possible to simultaneously lay a plurality of fibre ribbons. The expression “fibre ribbon” is understood to mean a group of fibres. Generally, a ribbon is planar and has a small width, of around a centimetre or less. To give an order of magnitude, a fibre ribbon may have a width of around 12 mm, 6 mm or 3 mm.

In the rest of the description, a fibre is understood to mean an elongate element which may consist of a single fibre or of a plurality of fibres in the manner of a ribbon. The term “preform” is understood to mean a volume of fibres disposed in a predetermined arrangement, obtained in particular by superposing layers of fibres on top of one another on a surface of a mould.

A laying surface corresponds to the surface of the mould in the case of the first layer of fibres or to the last layer laid in the case of the other layers.

FIG. 1 shows a mould 10 on which a preform 12 has been formed with the aid of a fibre placement machine 14.

This machine 14 comprises a fibre store 16, a mobile placement head 18, supported by a robot (not shown) such as an articulated arm, for example, and also means 20 for feeding fibres 22 from the store 16 to the placement head 18.

The placement head 18 comprises a roller 24 that is able to pivot about a rotation axis 26 moving above the laying surface 28, and means 30 for heating the laying surface at the front of the roller 24 in order to activate the resin of the fibres 22 positioned by the roller so as to promote the adhesion of the fibres to the laying surface in order that they stay in their positions.

In the rest of the description, the expression “longitudinal direction” is understood to mean a direction parallel to the rotation axis of the roller. The longitudinal plane corresponds to a plane containing the rotation axis. A transverse plane corresponds to a plane perpendicular to the rotation axis. A radial direction is a direction perpendicular to the rotation axis.

According to an embodiment illustrated in FIG. 2, the roller 24 comprises a cylindrical body 32 made of a single block with two spindle ends 34 at each end, said spindle ends being mounted in a pivoting manner in bearings 36 of a support 38 secured to the placement head. The spindle end 34/bearing 36 guidance makes it possible to define the rotation axis 26.

The support 38 exerts a force on the roller 24 in the direction of the laying surface 28 such that, at a lower generatrix 40, the roller 24 exerts a force on the fibres 22 to be placed in the direction of the laying surface 28.

The roller can pivot freely about the rotation axis 26. Its rotational movement about the rotation axis 26 results from the rolling of the roller 24 on the laying surface 28.

According to one embodiment, the cylindrical body 32 is made of elastomer coated with Teflon film.

The fibre store 26, also known as a creel, comprises a plurality of spools of fibres. The store 16 comprises means for exerting a constant tension on each of the fibres, regardless of the speed or acceleration of the placement head 18.

If the tension is not sufficient for a given fibre 22, the latter causes axial compression of the fibre 22 when it is compacted by the roller 24, causing folds in the fibre, as illustrated in FIG. 3A, these remaining included in the preform in the form of small undulations which impair the mechanical characteristics of the piece produced.

If the tension is too high for a given fibre 22, this causes bridging at a hollow in the piece, as illustrated in FIG. 3B, this bridging remaining included in the preform and resulting in a defect which may impact on the mechanical characteristics of the piece produced.

Fibre placement is carried out at ambient temperature greater than or equal to about 20° C. In this context, each fibre is unwound by the simultaneous combination of two effects:

The first effect results from the rolling of the roller on the fibre and should in theory make it possible to unwind a quantity of fibre equal to the distance covered by the roller if the fibre were only in contact with the roller at the lower generatrix 40 of the roller.

The second effect results from the adhesion of the fibre to the roller over a certain contact arc length A (visible in FIGS. 3A and 3B).

This latter effect generally results in defects for the following reasons.

Generally, the trajectory of the placement head is not necessarily rectilinear and may describe a curve. In this case, for a given displacement speed of the centre of the roller, the displacement speed Vext of a first end of the roller is greater than the displacement speed Vint of a second end of the roller in a curve. However, taking the second effect caused by the adhesion of the fibres to the roller into account, the tangential speed of each fibre is constant at the lower generatrix of the roller and equal to the rotational speed of the roller θ multiplied by the radius of the roller R.

Consequently, if Vext is greater than θ·R, the fibre Fext laid at this location is stretched too much, this tending to cause defects of the bridging type as illustrated in FIG. 3B. In parallel, if Vint is less than θ·R, the fibre Fint laid at this location is not stretched enough, and this tends to cause defects of the folding type as illustrated in FIG. 3A.

In order to limit the appearance of these defects, a first solution consists in laying dry fibres which are not pre-impregnated. In this case, the fibres can slide over the roller and be stretched adequately. However, this solution makes it necessary to use other polymerization techniques which have to allow the impregnation of the fibres with a resin.

These polymerization techniques are generally more complex to implement. In addition, since the fibres are not pre-impregnated they can slide with respect to one another in the preform and ultimately cannot be positioned correctly.

According to a second solution, it may be conceivable to reduce the length of the contact arc A in order to reduce the frictional forces between the fibres and the roller.

However, this solution may be difficult to implement since it makes it necessary to change the architecture of the placement head. In addition, a certain length of the contact arc is necessary to ensure guidance of the fibres. Thus, the reduction in the length of the contact arc results in deterioration in the precision of positioning the fibres in the longitudinal direction.

Document U.S. Pat. No. 6,390,169 proposes a third solution which consists in using a segmented roller 42 as illustrated in FIGS. 4A and 4B. Each roller segment 44 is dedicated to one fibre and may have a rotational speed different from those of the other segments. Thus, the rotational speed of each roller segment is adapted to the speed of movement of the point of said segment in contact with the laying surface. As a result, each fibre is stretched correctly.

Even though it limits the risks of the appearance of defects of the bridging or folding type, this solution is not entirely satisfactory since the roller is relatively complex. Furthermore, since each segment has a large radius of around 35 mm, the roller does not make it possible to correctly apply the fibres to the laying surface if the latter has a hollow having a radius of curvature less than 35 mm.

Other objects, desirable features and characteristics will become apparent from the subsequent summary and detailed description, and the appended claims, taken in conjunction with the accompanying drawings and this background.

### SUMMARY

Thus, the present disclosure aims to remedy the drawbacks of the prior art.

To this end, the various teachings of the present disclosure provide a method for fibre placement with the aid of a roller that is able to pivot about a rotation axis and to lay a plurality of first pre-impregnated fibres on second pre-impregnated fibres of a laying surface by rolling over said laying surface, said first fibres being distributed along a lower generatrix of the roller and being in contact with an outer surface of said roller over a contact arc, characterized in that it comprises cooling the first pre-impregnated fibres in contact with the roller so as to enable them to slide on the outer surface of the roller and in heating the second pre-impregnated fibres of the laying surface that are located at the front of the roller so as to promote the adhesion of the first fibres to the second fibres of the laying surface.

This solution provides the same advantages as the dry fibres in the region of the roller. In addition, since the second fibres of the laying surface are heated, the first pre-impregnated fibres laid by the roller adhere and stay in their positions in the preform until the consolidation step.

In one example, the outer surface of the roller is cooled to a temperature Tf less than or equal to about 12° C.

Advantageously, the outer surface of the roller is cooled by circulating a heat transfer fluid in the roller.

In one example, the roller comprises a fluid circuit with a supply of heat transfer fluid at a temperature for lowering the outer surface of the roller to the temperature Tf and keeping it at this temperature, and an outlet for evacuating the heat transfer fluid.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a perspective view of a placement machine according to the prior art;

FIG. 2 is a front view of a roller of a placement machine according to the prior art;

FIG. 3A is a side view of the roller from FIG. 2, which causes a first type of defect;

FIG. 3B is a side view of the roller from FIG. 2, which causes a second type of defect;

FIGS. 4A and 4B are front views of a roller according to the prior art in contact with contact surfaces having different profiles;

FIG. 5 is a longitudinal section through an exemplary embodiment of a roller of a fibre placement machine according to the various embodiments of the present disclosure;

FIG. 6A is a longitudinal section through another exemplary embodiment of a roller of a fibre placement machine according to various embodiments of the present disclosure;

FIG. 6B is a cross section through the roller from FIG. 6A; and

FIG. 7 is a longitudinal section through another exemplary embodiment of a roller of a fibre placement machine according to various embodiments of the present disclosure.

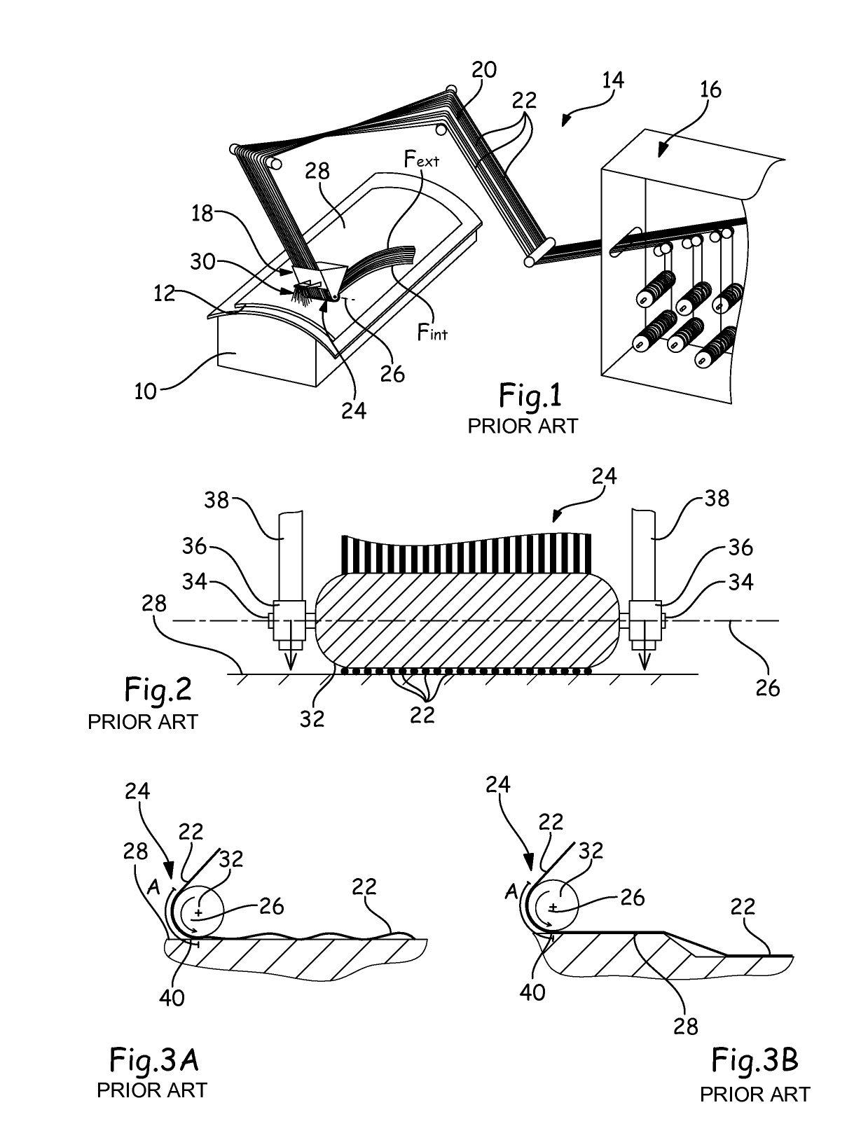

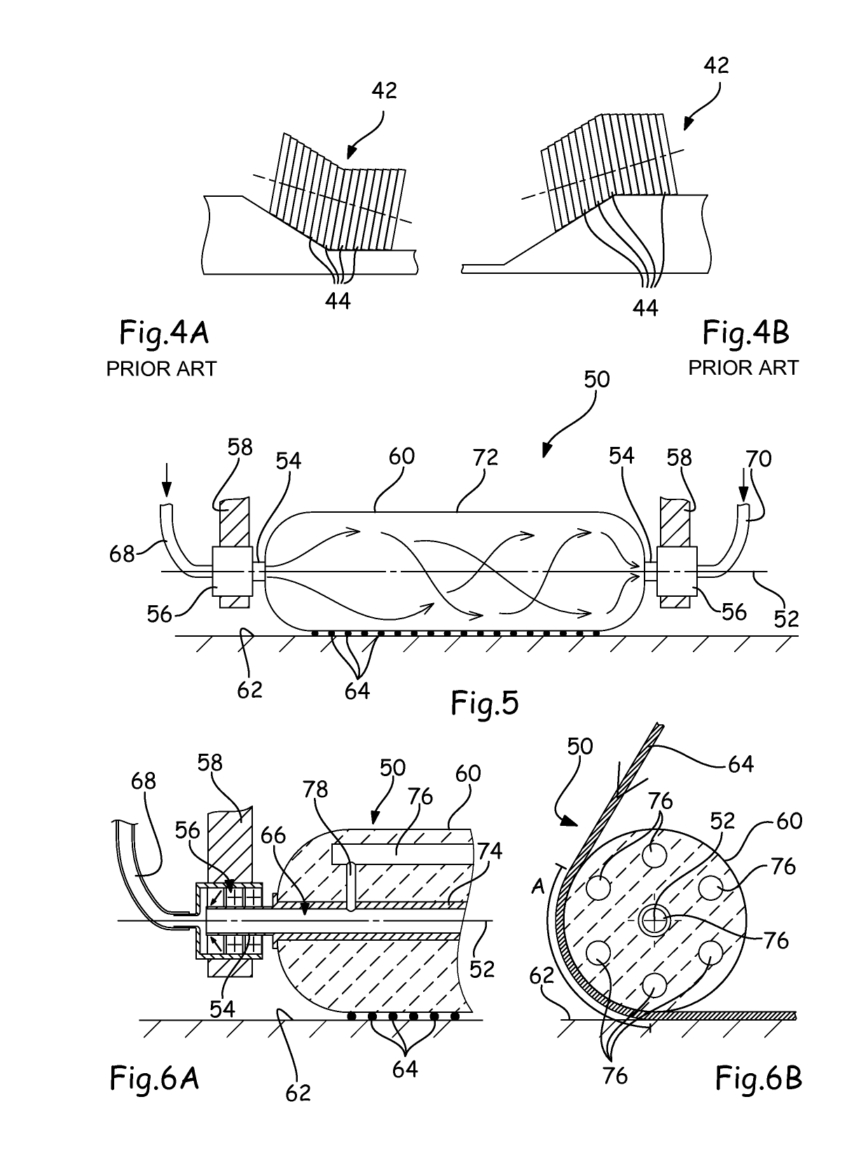

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

FIGS. 5, 6A, 6B and 7 show a roller 50 of a fibre placement machine that is able to pivot about a rotation axis 52.

As known to one skilled in the art, the roller 50 comprises means for connecting it to a placement head. According to one exemplary embodiment, the roller 50 comprises at each end a spindle end 54 that is mounted so as to be able to pivot in a bearing 56 of a support 58 secured to the placement head. The spindle end 54/bearing 56 guidance makes it possible to define the rotation axis 52. The placement machine and the connection between the roller and the placement head are not described in more detail since they are known to a person skilled in the art and since the roller 50 according to the various teachings of the present disclosure is more specifically suitable for being mounted on existing fibre placement machines in place of existing rollers.

According to one embodiment, the roller 50 comprises an approximately cylindrical outer surface 60 which can roll on a laying surface 62 so as to place fibres 64. As illustrated in FIG. 6B, each fibre 64 is in contact with the outer surface 60 over a contact arc A which depends on the architecture of the placement head. To give an order of magnitude, this contact arc A has a length which is greater than one quarter of the circumference of the roller and less than half of the circumference.

The fibres 64 are pre-impregnated with a resin. The fibres and the resin are selected depending on the piece to be produced.

At ambient temperature, greater than or equal to about 20° C., the pre-impregnated fibres 64 have relatively high tack which gives the fibres a bonding ability and adhesion to the laying surface 62, allowing the fibres to stay in their positions until the consolidation step.

According to the various teachings of the present disclosure, the roller 50 comprises means for cooling the pre-impregnated fibres 64 in contact therewith, over at least a portion of the contact arc A in order to reduce the tack of said fibres such that they lose their bonding ability. As a result, if necessary, the fibres 64 can slide over the outer surface 60 so as to compensate for the different lengths of fibre laid from one fibre to another on account in particular of the trajectory of the placement head or of the geometry of the laying surface 62.

Advantageously, the roller 50 comprises means for cooling the outer surface 60 which, by conduction, cools the fibres 64 over at least a portion of the contact arc A. The means for cooling the outer surface 60 make it possible to lower its temperature and to keep it at a temperature less than Tf °, starting from which a loss of bonding ability of the resin which impregnates the fibres can be observed.

By loss of bonding ability, the fibres will be expected to be able to slide on the outer surface 60 if necessary during their placement on the laying surface.

For the majority of resins used in the aeronautical field, the temperature of the outer surface 60 should be less than or equal to approximately 12° C.

In one example, the cooling means cool the outer surface around its entire circumference.

As a complement to the cooling means, the fibre placement machine comprises means for heating the fibres of the laying surface 62 that are located at the front of the roller 50. According to one exemplary embodiment, these means for heating the fibres are secured to the placement head. By way of example, the means for heating the fibres comprise at least one infrared lamp.

When the fibres 64 come into contact with the laying surface 62, the upper part of the fibres is at a temperature less than Tf and does not adhere to the outer surface 60 of the roller 50, whereas the lower part of the fibres in contact with the heated laying surface 62 adheres to the latter since the pre-impregnated resin on the fibres is “reactivated”, thereby ensuring that the fibres unwind and are positioned correctly.

In one example, the cooling means use a heat transfer fluid which circulates inside the roller 50 which, to this end, comprises a fluid circuit 66.

Advantageously, the means for cooling the heat transfer fluid are located outside the roller.

In this case, the fluid circuit 66 comprises a supply 68 of heat transfer fluid at a “cold” temperature for lowering the outer surface 60 to a temperature less than Tf and keeping it at this temperature, and an outlet 70 for evacuating the heat transfer fluid.

This solution has the advantage of allowing the evacuation of calories which the roller 50 accumulates by rolling over a heated laying surface 62.

The placement machine comprises means for controlling the temperature and the flow rate of the heat transfer fluid in order to obtain the appropriate temperature at the outer surface 60 of the roller.

According to one embodiment which is illustrated in FIG. 5, the roller 50 comprises a hollow cylinder 72 having a thin and rigid wall, having a side wall at each end, each side wall comprising an orifice which is centred with respect to the rotation axis, one of the orifices communicating with the supply 68 of heat transfer fluid and the other orifice communicating with the outlet 70 for the heat transfer fluid. According to this embodiment, the fluid circuit 66 corresponds to the interior of the hollow cylinder 72.

According to another embodiment which is illustrated in FIGS. 6A and 6B, the roller 50 is solid and comprises a fluid circuit 66 having a plurality of longitudinal ducts 76 located close to the outer surface 60. According to one embodiment, the fluid circuit 66 comprises a central duct 74 which is coaxial with the rotation axis 52 which extends along the entire length of the roller 50, one of its ends being connected to the supply 68 of heat transfer fluid and its other end being connected to the outlet 70 for heat transfer fluid.

The longitudinal ducts 76 are distributed around the entire circumference of the roller so as to obtain a temperature which is as homogeneous as possible at the outer surface 60. The longitudinal ducts 76 extend along virtually the entire length of the roller and are parallel to the central duct 74.

As a complement, the circuit 66 comprises radial ducts 78, one for each end of the longitudinal ducts 76, which allow the longitudinal ducts to be brought into communication with the central duct. Compared with the embodiment illustrated in FIG. 5, this solution improves heat exchanges between the heat transfer fluid and the outer surface of the roller.

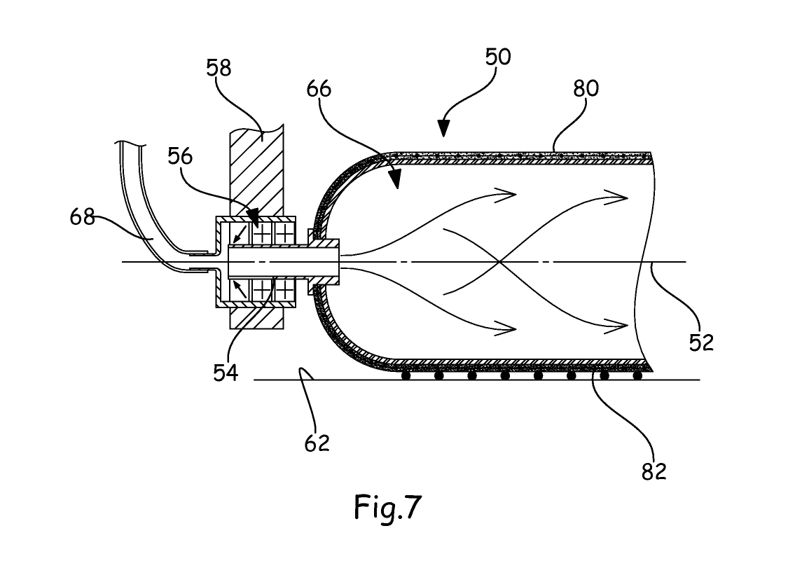

According to another embodiment which is illustrated in FIG. 7, the roller 50 comprises a hollow cylinder 80 having a deformable wall. In this case, the fluid circuit 66 corresponds to the interior of the hollow cylinder 80.

Advantageously, the roller 50 comprises means for altering its capacity to deform. According to one embodiment, the placement machine comprises means for regulating the pressure of the heat transfer fluid and in this way to modulate the capacity of the hollow cylinder 80 to deform. The higher the pressure, the more the deformation of the roller is limited.

This solution makes it possible to distribute the force applied to the fibres in a better manner, along the lower generatrix of the roller, and to obtain a uniform pressure on the fibres, in the case of a discontinuity of the laying surface.

According to one exemplary embodiment, the hollow cylinder 80 comprises a tread strip which is made of deformable material and is reinforced by a reinforcement 82. This transverse and/or longitudinal reinforcement 82, obtained by coiling threads for example, makes it possible to avoid radial expansion on account of the pressure and gives the tread strip good flexural rigidity.

The roller 50 according to various embodiments may also be used in a step subsequent to the placement of the fibres, said step comprising compacting the preform in the hot state. In this case, the roller comprises means for heating the fibres in contact therewith. According to one embodiment, it is possible to use the above-described rollers by circulating a “hot” heat transfer fluid, the temperature and flow rate of which make it possible to heat the fibres to the temperature required for compacting.

Whatever the application, a roller according to the various embodiments of the present disclosure comprises means for regulating the temperature of the fibres in contact therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A method for fibre placement with the aid of a roller that is able to pivot about a rotation axis and to lay a plurality of first pre-impregnated fibres on second pre-impregnated fibres of a laying surface by rolling over said laying surface, said first fibres being distributed along a lower generatrix of the roller and being in contact with an outer surface of said roller over a contact arc, the method comprising:
cooling the first pre-impregnated fibres in contact with the roller so as to enable them to slide on the outer surface of the roller; and
heating the second pre-impregnated fibres of the laying surface that are located at the front of the roller so as to promote the adhesion of the first fibres to the second fibres of the laying surface.

2. The method for fibre placement according to claim 1, wherein the outer surface of the roller is cooled to a temperature Tf less than or equal to 12° C.

3. The method for fibre placement according to claim 2, further comprising circulating a heat transfer fluid in the roller in order to cool it.

4. The method for fibre placement according to claim 3, comprising using means for cooling the heat transfer fluid outside the roller, the roller comprising a fluid circuit with a supply of heat transfer fluid at a temperature for lowering the outer surface of the roller to the temperature Tf and keeping it at the temperature Tf, and an outlet for evacuating the heat transfer fluid.

5. The method for fibre placement according to claim 4, wherein the roller comprises a hollow cylinder with a thin wall, having a side wall at each end, each side wall comprising an orifice which is centred with respect to the rotation axis, one of the orifices communicating with the supply of heat transfer fluid and the other orifice communicating with the outlet for the heat transfer fluid.

6. The method for fibre placement according to claim 5, wherein the thin wall of the roller is deformable and comprises a reinforcement for avoiding radial expansion.

7. The method for fibre placement according to claim 6, comprising regulating the pressure of the heat transfer fluid inside the roller.

8. The method for fibre placement according to claim 4, wherein the roller is a solid roller comprising:
a central duct, coaxial with the rotation axis, which extends along the entire length of the roller, one of its ends being connected to the supply of heat transfer fluid and its other end being connected to the outlet for the heat transfer fluid,
a plurality of longitudinal ducts which are positioned close to the outer surface, and distributed around the entire circumference of the roller so as to obtain a temperature which is as homogeneous as possible at the outer surface, the plurality of longitudinal ducts extending along virtually the entire length of the roller parallel to the central duct, and
a plurality of radial ducts, one for each end of the plurality of longitudinal ducts, which allow the plurality of longitudinal ducts to be brought into communication with the central duct.

9. A system for fibre placement, comprising:
a roller that is able to pivot about a rotation axis and to lay a plurality of first pre-impregnated fibres on second pre-impregnated fibres of a laying surface by rolling over said laying surface, said first fibres being distributed along a lower generatrix of the roller and being in contact with an outer surface of said roller over a contact arc,
wherein outer surface of the roller is cooled to a temperature Tf less than or equal to 12° C.

10. The system for fibre placement according to claim 9, further comprising circulating a heat transfer fluid in the roller in order to cool it.

11. The system for fibre placement according to claim 10, comprising means for cooling the heat transfer fluid outside the roller, the roller comprising a fluid circuit with a supply of heat transfer fluid at a temperature for lowering the outer surface of the roller to the temperature Tf and keeping it at the temperature Tf, and an outlet for evacuating the heat transfer fluid.

12. The system for fibre placement according to claim 11, wherein the roller comprises a hollow cylinder with a thin wall, having a side wall at each end, each side wall comprising an orifice which is centred with respect to the rotation axis, one of the orifices communicating with the supply of heat transfer fluid and the other orifice communicating with the outlet for the heat transfer fluid.

13. The system for fibre placement according to claim 12, wherein the thin wall of the roller is deformable and comprises a reinforcement for avoiding radial expansion.

14. The system for fibre placement according to claim 13, wherein the roller is a solid roller comprising:
a central duct, coaxial with the rotation axis, which extends along the entire length of the roller, one of its ends being connected to the supply of heat transfer fluid and its other end being connected to the outlet for the heat transfer fluid,
a plurality of longitudinal ducts which are positioned close to the outer surface, and distributed around the entire circumference of the roller so as to obtain a temperature which is as homogeneous as possible at the outer surface, the plurality of longitudinal ducts extending along virtually the entire length of the roller parallel to the central duct, and
a plurality of radial ducts, one for each end of the plurality of longitudinal ducts, which allow the plurality of longitudinal ducts to be brought into communication with the central duct.
